(19) United States
(12) Patent Application Publication
(10) Pub. No.: US 2025/0203247 A1
(43) Pub. Date: Jun. 19, 2025

(54) Transmission of Pre-Processed Sensor Data While Incorporating Data Quality

(71) Applicant: Siemens Aktiengesellschaft, München (DE)

(72) Inventors: Christoph Scholl, Neuenstein (DE); Andreas Tobola, Erlangen (DE); Klaus Ludwig, Erlangen (DE)

(73) Assignee: Siemens Aktiengesellschaft, München (DE)

(21) Appl. No.: 18/839,149

(22) PCT Filed: Feb. 9, 2023
(86) PCT No.: PCT/EP2023/053150

§ 371 Date: Aug. 16, 2024

(30) Foreign Application Priority Data
Feb. 18, 2022 (EP) 22157470.0

(51) Int. Cl. H04Q 9/00

(52) U.S. Cl. CPC H04Q 9/00; H04Q 2209/823; H04Q 2209/826; H04Q 2209/84

(57) ABSTRACT

Various embodiments of the teachings herein include a method for transmitting pre-processed sensor data. An example includes: measuring values with a sensor unit, the measured values having an associated available data quality indicating a quality for the measured values; receiving a data quality demanded by a receiver; processing the measured values according to the available data quality and the demanded data quality to form pre-processed sensor data; transmitting the pre-processed sensor data and the available data quality to the receiver; receiving a response according to the available data quality from the receiver; processing the measured values according to the response to form further pre-processed sensor data; and transmitting the further pre-processed sensor data and the available data quality to the receiver.

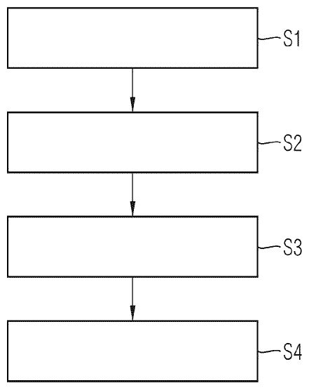

### CROSS-REFERENCE TO RELATED APPLICATIONS

This application is a U.S. National Stage Application of International Application No. PCT/EP2023/053150 filed Feb. 9, 2023, which designates the United States of America, and claims priority to EP Application Serial No. 22157470.0 filed Feb. 18, 2022, the contents of which are hereby incorporated by reference in their entirety.

### TECHNICAL FIELD

The present disclosure relates to sensors. Various embodiments of the teachings herein include methods for and/or systems transmitting pre-processed sensor data.

### BACKGROUND

In heterogeneous systems in Internet-of-Things environments (IoT environments), large volumes of data are produced and processed. Sensor data, which can also be referred to as measured values, are often transferred from the field level via gateway devices to the cloud without checks, ignoring any problems in respect of data quality. Additionally, only individual data points or a pre-processed aggregated or compressed value are/is transmitted for reasons of cost, in particular the energy budget of the sensor system, or for reasons of communication bandwidth. This results in the measured value losing information compared with the raw data. The already compressed transmission of the sensor data means that a subsequent diagnosis is, at best, only just possible with great difficulty, but is usually not possible at all.

### SUMMARY

The teachings of the present disclosure include methods and systems for improved transmission of sensor data. For example, some embodiments include a method for transmitting pre-processed sensor data, comprising: measuring (S1) measured values by way of a sensor unit, the measured values having an associated available data quality, which is a measure of quality for the measured values, receiving (S2) a data quality demanded by a receiver, processing (S3) the measured values according to the available data quality and the demanded data quality to form pre-processed sensor data, and transmitting (S4) the pre-processed sensor data and the available data quality to the receiver, receiving a response according to the available data quality from the receiver, processing the measured values according to the response to form further pre-processed sensor data, and transmitting the further pre-processed sensor data and the available data quality to the receiver.

In some embodiments, the method further comprises: receiving a second response according to the available data quality from the receiver, and transmitting the measured values and the available data quality to the receiver.

In some embodiments, the method further comprises storing the measured values by way of the sensor unit.

In some embodiments, the sensor unit and the receiver use the same communication protocol.

In some embodiments, the available data quality is determined by the sensor unit.

In some embodiments, the available data quality is determined by: an algorithm for anomaly detection and/or a machine learning algorithm.

In some embodiments, the receiver is in the form of: a gateway device, a cloud server, a fog server or an edge device.

In some embodiments, the method further comprises retrieving desired transmission intervals from the receiver.

In some embodiments, data from the step of processing the measured values according to the available data quality and the demanded data quality are also transmitted with the pre-processed sensor data.

In some embodiments, the processing of the sensor data comprises: an aggregation and/or a filtering and/or a compression and/or a calculation of the root mean square value (RMS value).

In some embodiments, the method further comprises receiving a quality scale on the basis of which the data quality is scaled.

As another example, some embodiments include a sensor unit designed to carry out one or more of the methods described herein.

In some embodiments, sensor unit comprises: a measuring element designed to measure measured values, the measured values having an associated available data quality, which is a measure of quality for the measured values, a receiving unit designed to receive a data quality demanded by a receiver, a processing unit designed to process the measured values according to the available data quality and the demanded data quality to form pre-processed sensor data, and a transmitting unit designed to transmit the pre-processed sensor data and the available data quality to the receiver.

As another example, some embodiments include a system having a sensor unit as described herein and an associated receiver.

### BRIEF DESCRIPTION OF THE DRAWINGS

The special features and advantages of the teachings herein are apparent from the explanations of multiple exemplary embodiments hereinbelow with reference to the schematic drawings, in which

The single FIGURE shows a flowchart for an example method incorporating teachings of the present disclosure.

### DETAILED DESCRIPTION

Some examples of the teachings herein include a method for transmitting pre-processed sensor data, comprising: measuring measured values by way of a sensor unit, the measured values having an associated available data quality, which is a measure of quality for the measured values, receiving a data quality demanded by a receiver, processing the measured values according to the available data quality and the demanded data quality to form pre-processed sensor data, and transmitting the pre-processed sensor data and the available data quality to the receiver, receiving a response according to the available data quality from the receiver, processing the measured values according to the response to form further pre-processed sensor data, and transmitting the further pre-processed sensor data and the available data quality to the receiver.

The data are transmitted to the receiver according to the data quality demanded by said receiver. The data quality demanded by the receiver can be received in particular from a memory or directly from the receiver. The receiver uses the demanded data quality to define requirements for a minimum of data quality. If the data quality is predefined at a higher level than by the receiver, the sensor data, which can also be referred to as data, can be sent to the receiver as fast as possible. If the data quality is lower than the threshold predefined by the receiver, these data can be stored on the sensor unit, which can also be referred to as a transmitter, or on a sensor system.

If required, in particular as soon as the additionally received data quality is below a minimum, the receiver can also request all or some sensor data buffer-stored by the transmitter that are related to the poor data quality. Additional data or the raw data can be requested instead of aggregated data in this case.

A data quality rating assigned to the sensor signals is used in the additional processing chain in order to control the communication of the sensor. In particular if the data quality is poor, the receiver of the pre-processed sensor data can subsequently request additional sensor data. To this end, the sensor can keep data from the past in the sensor system for a specific period of time. These additional data can then be stored and processed further for diagnosis and documentation purposes. This has the advantage that it permits events, in particular errors, to be traced to specific sensor data.

In some embodiments, the method includes: receiving a second response according to the available data quality from the receiver, and transmitting the measured values and the available data quality to the receiver. In particular if the data quality is poor, the receiver of the pre-processed sensor data can subsequently request additional sensor data. These may be in particular raw data in the unprocessed state.

To this end, the receiver can moreover have a control algorithm that ensures that the available resources of the sensor system, in particular available energy budget, maximum communication data rate, internal memory for buffer storage, are not exceeded. The stored data are unprocessed data, and also processed data, with the associated metadata, in particular timestamps and quality information.

The transmitter can take its own limitations, in particular available energy budget, maximum communication data rate, as a basis for denying requests for sensor signals. This may be the case if processing the additional data quality information or sending the past values would endanger the core function of the sensor.

Depending on the requirements for the data quality, the receiver can also request just a portion of the sensor data for diagnosis purposes. In one embodiment, if the demanded data quality is not reached only marginally, the receiver could request only the value that has caused the poor data quality. The additionally requested portion of the data can also be specified with a start and end time, i.e. first data point and last data point.

In some embodiments, the method includes storing the measured values by way of the sensor unit. The measured value can be stored in a memory of the sensor unit. Additionally, the receiver can specify which data marked as poor quality, which have therefore not been sent immediately, are stored. This may be all data or a selection based on quality and data type.

The transmitter is able to keep measurement results from past measurements in the internal memory and to send them via the communication interface when necessary and on special request. The internal memory of the transmitter can be managed according to the available data quality to the effect that the available data quality is taken as a basis for storing values at a higher sampling rate, in particular in the case of a poorer data quality DO, or at a lower sampling rate, in particular in the case of a higher data quality. The higher sampling rate when the data quality is lower therefore means that more values are stored.

Using an algorithm, the receiver can independently decide which values are stored with which storage depth. In particular, if a specific quality value, i.e. the data quality, is below a threshold but the other available quality values show no deterioration, it can use the available memory of the transmitter just for the poorer value. This also applies to the basic data used to calculate the quality value. This function can be disabled.

In some embodiments, the sensor unit and the receiver use the same communication protocol. This has the advantage of uncomplicated data interchange.

In some embodiments, the available data quality is determined by the sensor unit. This has the advantage that the sensor unit itself is aware of the quality of the data it captures. The available data quality can be taken as a basis for transmitting the data.

In some embodiments, the available data quality is determined by: an algorithm for anomaly detection and/or a machine learning algorithm. The learning algorithm could specifically be a neural network or a one-class support vector machine.

Data quality in the context of the present disclosure means a quality of the measured values recorded by the sensor unit. The quality describes how accurately the variables relating to the measured values are recorded. The variables can relate in particular to temperature, humidity, voltage, magnetic field strength, shaking, vibration and/or acceleration. A higher data quality means that the recorded measured values correspond to the values that are actually present with a lower level of variance, or a higher level of match, than in the case of a lower data quality. Data quality can be adversely affected by aging of the sensor unit and/or influences of ambient conditions.

In some embodiments, data quality consists of at least one value, but in particular of a tuple of related values that, as such, describe the quality of the measured data. Every datum (time series, calculated value) has its specific tuple, which rates the quality of this datum. A tuple Q can preferably consist of three quality values Q1, Q2 and Q3: QA=(QA1, QA2, QA3), the tuple QA describing the quality of a parameter A. More or fewer than three quality values are also possible.

The value range of data quality is generally in the interval (0,1), where 0 is the worst possible data quality and 1 is the best possible data quality, the data quality not needing to be in that range.

For all elements in a tuple, the receiver defines data quality threshold values for:

1) data that are sent from the transmitter to the receiver immediately.

2) For the remaining data, that is to say for the data that are intended to be stored, the receiver can set a limit in the same way. It can also make a selection here regarding data type, irrespective of quality, in particular can select only one specific data type. If the receiver provides no information in this regard, all data are stored so long as the memory is sufficient.

In some embodiments, the receiver is in the form of: a gateway device, a cloud server, a fog server or an edge device.

In some embodiments, the method includes retrieving desired transmission intervals from the receiver. The receiver stipulates when and indirectly also how often and how much data it receives.

In some embodiments, data from the step of processing the measured values according to the available data quality and the demanded data quality are also transmitted with the pre-processed sensor data. This has the advantage that the receiver also receives data relating to the way in which the measured values are pre-processed.

In some embodiments, the processing of the sensor data comprises: an aggregation and/or a filtering and/or a compression and/or a calculation of the root mean square value (RMS value). Thus, the volume of data to be transmitted is reduced.

In some embodiments, the method includes receiving a quality scale on the basis of which the data quality is scaled. Thus, the transmitter and the receiver use an identically scaled measure of data quality and therefore understand the same by good or less good data quality. This may be implemented by machine learning. This step can also comprise negotiating data quality between the receiver and the transmitter. In particular, the receiver can also calculate different categories of data quality values.

Some embodiments include a sensor unit designed to carry out one or more of the methods described herein.

In some embodiments, the sensor unit includes: a measuring element designed to measure measured values, the measured values having an associated available data quality, which is a measure of quality for the measured values, a receiving unit designed to receive a data quality demanded by a receiver, a processing unit designed to process the measured values according to the available data quality and the demanded data quality to form pre-processed sensor data, and a transmitting unit designed to transmit the pre-processed sensor data and the available data quality to the receiver.

The processing unit can also be referred to as a processor. The receiving unit may be designed to receive the demanded data quality from a memory or directly from the receiver. The transmitting unit may be in the form of a communication interface.

Some embodiments include a system having a sensor unit as described herein and an associated receiver.

Use of these teachings may provide improved traceability of events on the basis of data-quality-based sensor communication and transmission of sensor data and measured values, including optimized sensor data communication under limiting constraints, in particular energy budget and communication bandwidth, or possibility of optimization, in particular for communication bandwidth: a smaller bandwidth can suffice, since fewer data need to be transmitted on average and more data are transmitted only in the event of an error.

The FIGURE shows a flowchart for an example method incorporating teachings of the present disclosure. The method shown includes: step S1: measuring measured values by way of a sensor unit, the measured values having an associated available data quality, which is a measure of quality for the measured values, step S2: receiving a data quality demanded by a receiver, step S3: processing the measured values according to the available data quality and the demanded data quality to form pre-processed sensor data, and step S4: transmitting the pre-processed sensor data and the available data quality to the receiver.

In some embodiments, the method further includes: receiving a response according to the available data quality from the receiver, processing the measured values according to the response to form further pre-processed sensor data, and transmitting the further pre-processed sensor data and the available data quality to the receiver.

Although the teachings herein have been illustrated and described more thoroughly in detail by way of the exemplary embodiments, the invention is not limited by the disclosed examples, and other variations can be derived therefrom by a person skilled in the art without departing from the scope of protection thereof.

What is claimed is:

1. A method for transmitting pre-processed sensor data, the method comprising:
measuring values with a sensor unit, the measured values having an associated available data quality, indicating a quality for the measured values;
receiving a data quality demanded by a receiver;
processing the measured values according to the available data quality and the demanded data quality to form pre-processed sensor data; and
transmitting the pre-processed sensor data and the available data quality to the receiver;
receiving a response according to the available data quality from the receiver;
processing the measured values according to the response to form further pre-processed sensor data; and
transmitting the further pre-processed sensor data and the available data quality to the receiver.

2. The method as claimed in claim 1, further comprising:
receiving a second response according to the available data quality from the receiver; and
transmitting the measured values and the available data quality to the receiver.

3. The method as claimed in claim 1, further comprising:
storing the measured values with the sensor unit.

4. The method as claimed in claim 1, wherein the sensor unit and the receiver use matched communication protocol.

5. The method as claimed in claim 1, wherein the sensor unit determines the available data quality.

6. The method as claimed in claim 1, wherein the available data quality is determined by:
an algorithm for anomaly detection and/or
a machine learning algorithm.

7. The method as claimed in claim 1, wherein the receiver comprises one of:
a gateway device,
a cloud server,
a fog server, or
an edge device.

8. The method as claimed in claim 1, further comprising
retrieving desired transmission intervals from the receiver.

9. The method as claimed in claim 1, further comprising transmitting data resulting from the processing the measured values according to the available data quality and the demanded data quality along with the pre-processed sensor data.

10. The method as claimed in claim 1, wherein processing of the sensor data comprises:
an aggregation and/or
a filtering and/or
a compression and/or
a calculation of the root mean square value (RMS value).

11. The method as claimed in claim 1, further comprising
receiving a quality scale on the basis of which the data quality is scaled.

12. (canceled)

13. A sensor unit comprising:
a measuring element to capture measured values with an associated available data quality indicating a quality for the measured values;
a receiver to receive a data quality demanded from a receiver;
a processing unit to process the measured values according to the available data quality and the demanded data quality to form pre-processed sensor data; and
a transmitter to transmit the pre-processed sensor data and the available data quality to the receiver.

14. (canceled)
